(19) United States
(12) Patent Application Publication
(10) Pub. No.: US 2008/0272885 A1
(43) Pub. Date: Nov. 6, 2008

(54) Modular Radio Frequency Identification Tagging Method

(75) Inventor: Peter Samuel Atherton, Leesburg, VA (US)

Correspondence Address: BUCHANAN, INGERSOLL & ROONEY PC, POST OFFICE BOX 1404, ALEXANDRIA, VA, 22313-1404, US

(73) Assignee: MIKOH Corporation, McClean, VA (US)

(21) Appl. No.: 10/586,738

(22) PCT Filed: Jan. 21, 2005
(86) PCT No.: PCT/US2005/001884

§ 371 Date: Jul. 18, 2008

Related U.S. Application Data
(60) Provisional application No. 60/537,889, filed on Jan. 22, 2004.

(51) Int. Cl. G08B 13/14; H04Q 5/22

(52) U.S. Cl. 340/10.1; 340/572.7; 340/572.8

(57) ABSTRACT

The RF antenna portion and the RFID electronics portion of an RFID tag are produced separately and assembled on the item to be tagged. This reduces the overall cost of the RFID tagging process, in addition to providing other benefits. Specifically, the RF antenna is pre-applied to an item that is to be tagged and the RFID electronics are applied separately to the item in the form of a discrete RFID electronics module that couples to the pre-applied RF antenna to provide an RFID capability for the item.

### BACKGROUND TO THE INVENTION

Radio frequency identification (RFID) labels and tags are expected to enable the next generation of automated item identification technology. (In this document the terms “label” and “tag” are used interchangeably.) In particular it is expected that self-adhesive RFID labels and tags will be used extensively to tag items and containers.

In order for RFID tagging to be widely adopted it will need to be low-cost. The current conventional means of providing self-adhesive RFID tags involves producing discrete RFID tags that each includes all of the components needed to provide a complete RFID capability, and applying such tags to the items to be tagged. A disadvantage of this approach is that the production of complete, discrete RFID tags is intrinsically costly. Another disadvantage of this approach is that conventional RFID tags include relatively fragile components, and if applied to an item during the early stages of the item's manufacturing or packaging they may be damaged and rendered inoperative.

### DISCLOSURE OF THE INVENTION

There is disclosed herein a method and device for providing a low-cost radio frequency identification (RFID) capability for an item. In an exemplary embodiment of the invention, the method comprises: providing an item to be provided with an RFID capability; applying a radio frequency (RF) antenna directly to said item, preferably but not necessarily by printing said RF antenna on said item; providing an RFID electronics module that is separate from said item and said RF antenna, said RFID electronics module containing RFID electronics that provide an RFID capability when electrically coupled to said RF antenna and including a means to be applied to said item so as to be electrically coupled to said RF antenna on said item; applying said RFID electronics module to said item in a manner so as to couple said RFID electronics module to said RF antenna and thereby provide an RFID capability for said item.

Preferably, but not necessarily, said means of application of said RFID electronics module to said item may be an adhesive.

### BRIEF DESCRIPTION OF THE FIGURES

The principles of the disclosed embodiments of the present invention will now be described by way of non-limiting example with reference to the schematic illustrations in FIGS. 1 to 3, wherein:

FIGS. 1 and 2 are schematic illustrations of a preferred embodiment of the current invention, showing an item with a pre-applied RF antenna and an RFID electronics module being applied to the item in the vicinity of said RF antenna so as to couple to said RF antenna and thereby provide a complete RFID function for said item; and

FIG. 3 is a schematic illustration of one preferred embodiment of the RFID electronics module illustrated in FIGS. 1 and 2.

### DETAILED DESCRIPTION OF THE INVENTION

In general an RFID tag provides the capability to store information electronically and to enable the stored information to be read from a distance by means of radio frequency (RF) techniques. In some cases an RFID tag may enable modification of said stored information.

An RFID tag typically comprises two distinct components:
an RF antenna; and
RFID electronics that are coupled to said RF antenna to provide an RFID capability.

In a conventional RFID tag both the RF antenna and the RFID electronics are integrated into the tag at the time of manufacture of the tag, so that the tags are produced as discrete, fully functional RFID devices that are applied to items to be tagged.

In comparison, according to embodiments of the present invention, the RF antenna portion and the RFID electronics portion of an RFID tag are produced separately and assembled on the item to be tagged. This reduces the overall cost of the RFID tagging process, in addition to providing other benefits. Specifically, in the disclosed embodiment of the present invention the RF antenna is pre-applied to an item that is to be tagged and the RFID electronics are applied separately to the item in the form of a discrete RFID electronics module that couples to the pre-applied RF antenna to provide an RFID capability for said item. It should be appreciated that the RFID electronics module may include an antenna portion that contributes to the overall antenna function of the combined RF antenna plus RFID electronics module, and further that this antenna portion may be used to couple the RFID electronics module and pre-applied RF antenna.

It should be appreciated that the term “item” as used herein is used in its broadest sense, and may for example refer to a product, product packaging, or container.

The pre-applied RF antenna has no RFID capability in its own right, before the RF electronics module is applied.

Preferably, but not necessarily, the pre-applied RF antenna may be applied to an item by means of a printing process that may in one embodiment involve printing electrically conductive ink directly onto the surface of said item. Printing of said electrically conductive ink may be carried out in conjunction with printing of graphics, text, barcodes or other visible markings on said item.

It should be appreciated that in other embodiments the RF antenna may be made from materials other than electrically conductive inks. For example, in one embodiment the RF antenna may be made from a solid metal conductor or from a hybrid ink-plus-metal conductor.

Preferably, but not necessarily, the RFID electronics module may couple to the pre-applied RF antenna by means of a non-contact coupling method such as capacitive coupling or inductive coupling. The optimum non-contact coupling method will depend on factors such as the operating frequency of the RFID electronics module. In other embodiments the RFID electronics module may be directly connected to the RF antenna—i.e. by means of a direct physical electrical connection. It should be appreciated that the electronics in the RF electronics module that is used to couple or connect the RFID electronics module to the pre-applied RF antenna may itself constitute a portion of the antenna of the completed RFID tag.

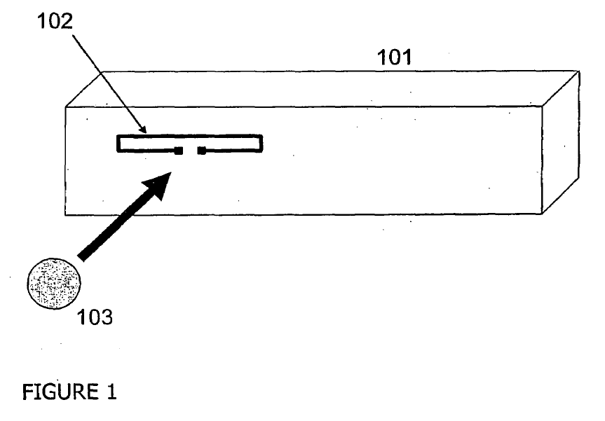

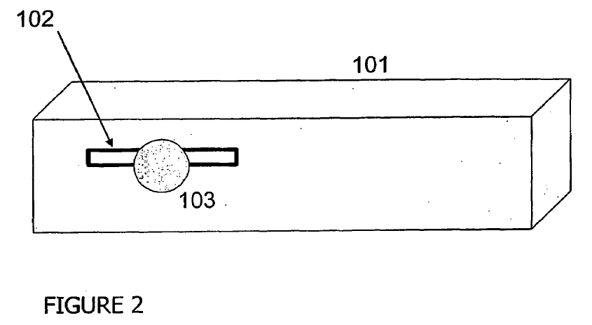

FIGS. 1 and 2 are schematic illustrations of one embodiment of the present invention. In the embodiment of FIGS. 1 and 2 an item 101 has an RF antenna 102 printed on it. An RFID electronics module 103 is subsequently applied to the item 101 in a specified position and orientation in the vicinity of the RF antenna 102 such that the RFID electronics in the module 103 couples to the RF antenna 102 to provide an RFID capability for the item 101. FIG. 1 shows the RFID electronics module 103 before application to the item 101, while FIG. 2 shows the RFID electronics module 103 after it has been applied to the item 101. In FIGS. 1 and 2 the RFID electronics module 103 is shown as having a circular shape, but it should be appreciated that other shapes and configurations for the RFID electronics module 103 are possible, while still embodying the principles described herein for the present invention. Similarly, a specific RF antenna design 102 is illustrated in FIGS. 1 and 2, but it should be appreciated that other RF antenna designs are possible, including induction loop designs for the RF antenna 102.

Preferably, but not necessarily, the RFID electronics module 103 may be applied to the item 101 by means of an adhesive on the RFID electronics module 103 or on the item 101.

The RFID electronics in the RFID electronics module 103 may be either “passive” or “active”. In this context the term “passive” means that the RFID electronics module 103 does not include a power source, while the term “active” means that the RFID electronics module 103 includes an on-board power source such as a battery.

In one preferred embodiment the RFID electronics module 103 is passive and the electronics in the module 103 comprises a single RFID integrated circuit (IC) connected to electrically conductive pads, or an electrically conductive circuit, thereby enabling non-contact coupling between the RFID electronics module 103 and the pre-printed RF antenna 102.

In the embodiment of FIGS. 1 and 2 the RFID electronics module 103 preferably couples to the RF antenna 102 by means of a non-contact coupling method such as capacitive coupling or inductive coupling.

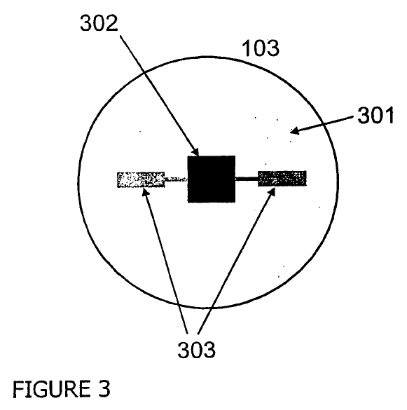

FIG. 3 is a schematic illustration of one preferred embodiment of the RFID electronics module 103. In FIG. 3 the RFID electronics module 103 consists of a substrate 301 to which is attached an RFID IC 302. The RFID IC 302 is connected to electrically conductive pads 303 that enable non-contact coupling between the RFID electronics module 103 and the pre-printed antenna 102, and that in some embodiments may also form part of the antenna of the combined RFID electronics module 103 plus pre-printed RF antenna 102. The substrate 301, RFID IC 302 and electrically conductive pads 303 may be covered with a layer of adhesive used to attach the RFID electronics module 103 to the item 101. In one embodiment the substrate 301 may be a thin flexible substrate material, while in another embodiment the substrate 301 may be a thicker material with recessed or contoured portions to house the RFID IC 302 and electrically conductive pads 303.

The electrically conductive pads 303 may be configured in any of a number of different ways, depending on the non-contact method used to couple the RFID electronics module 103 to the RF antenna 102. The illustration of the electrically conductive pads 303 shown in FIG. 3 is consistent with capacitive coupling being used to provide non-contact coupling between the RFID electronics module 103 and the pre-printed RF antenna 102. In the case of inductive coupling between the RFID electronics module 103 and the antenna 102 the electrically conductive pads 303 may form an induction loop connected to the RFID IC 302.

In a variation on the embodiment of the RFID electronics module 103 illustrated in FIG. 3, the RFID IC 302 may be designed to enable non-contact coupling to the RF antenna 102 without the need for electrically conductive pads 303, in which case the electrically conductive pads 303 may not be included in the RFID electronics module 103.

The use of non-contact coupling between the RFID electronics module 103 and the pre-printed RF antenna 102 avoids the need to establish a direct electrical connection between the RFID electronics module 103 and the pre-printed RF antenna 102, thereby making assembly of the RFID electronics module 103 on the item 101 easier. In order to enable or optimize non-contact coupling it may be necessary to apply a layer of dielectric material between the RF antenna 102 and the RFID electronics module 103, for example by printing said dielectric material over the RF antenna 102. In those embodiments where the RFID electronics module 103 is applied to the item 101 by means of an adhesive layer said adhesive layer may provide a suitable dielectric layer between the RF antenna 102 and the RFID electronics module 103.

In some embodiments non-contact coupling between the RF antenna 102 and the RFID electronics module 103 may occur through a substrate material that is part of the item 101, so that the RF antenna 102 may be on one surface of a substrate material and the RFID electronics module 103 may be applied to the opposite surface of said substrate material. For example, the RF antenna 102 may be printed on the inside surface of a product package and the RFID electronics module 103 may be applied in a specified position and orientation to the outside surface of said product packaging such that the RF antenna 102 couples to the RFID electronics module 103.

It should be appreciated that in order for non-contact coupling between the RF antenna 102 and the RFID electronics module 103 to be effective it may be necessary for the RFID electronics module 103 to be placed on the item 101 in a specified position and orientation relative to the RF antenna 102, within certain tolerances. Preferably, but not necessarily, the non-contact coupling means may be designed so as to allow some misalignment of the RFID electronics module 103 and the RF antenna 102 while still providing effective non-contact coupling and an effective RFID capability. For example, in the case of capacitive coupling between electrical contact pads on the RF antenna 102 and electrical contact pads on the RFID electronics module 103, one set of contact pads—either on the RF antenna 102 or on the RFID electronics module 103—may deliberately be made significantly larger than the other set and the contact pads may be spaced so as to allow a degree of misalignment of the RFID electronics module 103 relative to the RF antenna 102 while still providing effective capacitive coupling.

In one preferred embodiment the item 101 may include alignment marks to indicate where and how the RFID electronics module 103 should be placed to result in effective non-contact coupling to the RF antenna 102. In another preferred embodiment the item 101 may include surface features, such as a recessed area of specified size and shape, to aid in positioning of the RFID electronics module 103 on the item 101 and thereby produce effective non-contact coupling to the RF antenna 102. Similarly, the RFID electronics module 103 may include markings or colors or surface features to assist in applying the RFID electronics module 103 to the item 101 in the correct position and orientation so as to produce effective non-contact coupling between the RFID electronics module 103 and the RF antenna 102.

In some applications it may be important that the RFID electronics module 103 cannot be removed from an item 101 and reused on another item. Hence in some preferred embodiments the RFID electronics module 103 may be designed such that it will be damaged if it is removed after being applied to an item 101, thereby preventing the RFID electronics module 103 from being reused on another item. This self-destruct feature may result from (i) using a strong adhesive to attach the RFID electronics module 103 to the item 101; or (ii) including in the design of the RFID electronics module 103 certain weak points that are intended to break or separate or fail in some way if the RFID electronics module 103 is removed from the item 101; or (iii) other deliberately introduced design element(s) that result in damage to the RFID electronics module 103 if it is removed from the item 101.

One technique for providing a self-destruct feature is described in U.S. Patent Application Publication 20030075608. In that application, a tamper indicating label is described. The label may include RFID components and an electrically conductive tamper track coupled to the RFID components. The tamper track should be constructed from a destructible electrically conducting material such as electrically conductive ink. Additionally, the tamper track can be formed such that it is damaged when the label is tampered, thereby modifying or disabling the RFID function of the RFID components. In one embodiment, adhesion characteristics of the tamper track are adapted to break apart or otherwise damage the tamper track when the label is tampered, for example, by removal from an object. In this way the RFID capability of the RFID components may be disabled when the tamper track is damaged, indicating tampering. In one embodiment the label may be attached to a surface by means of an adhesive layer, with the tamper track between the label substrate (that includes the RFID components) and the adhesive layer. One or more layers of adhesion modifying formulation may be applied in a specific pattern between the RFID label substrate and the layer of adhesive, with the layers of adhesion modifying material modifying (by selectively increasing or decreasing) the adhesion of the layers that they separate, and thereby promoting damage to the tamper track if the RFID label is tampered or removed from the surface. Since the tamper track is electrically connected to the RFID components in the label, and may form part of the RFID components of the label, the RFID function of the label may be disabled or modified if the label is applied to a surface and subsequently tampered or removed.

These tamper resistant techniques may also be used to provide tamper resistance for the RFID electronics module 103, thereby preventing the RFID electronics module 103 from being removed from one item 101 and re-applied to a second item 101 to provide an RFID function for the second item 101.

In some applications it may be desirable for the RFID electronics module 103 to be easy to remove from the item 101. For example, there are at present privacy concerns among some consumer groups that RFID may be used as a tracking mechanism after an item is purchased, so it may be desirable to provide consumers an easy way to disable the RFID capability on any tagged items that they purchase. This could be achieved by allowing easy removal of the RFID electronics module 103 from the item 101, and in some embodiments designing the RFID electronics module 103, for example as described above, to be damaged and therefore unusable after it has been removed from the item 101.

I claim:

1. A method, comprising:
providing an RF antenna on an item; and
electrically coupling a separate RFID electronics module to the RF antenna on the item after the RF antenna is provided on the item;
thereby providing an RFID capability for the item.

2. The method of claim 1, wherein electrically coupling comprises attaching the RFID module to the Item to provide an RFID function for the item.

3. The method of claim 1 wherein the electrical coupling between the RF antenna and the RFID electronic module is a non-contact electrical coupling method.

4. The method of claim 1, wherein the item includes an inside surface and an outside surface and further comprising providing the RF antenna on the inside surface of the Item and attaching the RFID electronics module in an adjacent position to the outside surface of the item.

5. The method of claim 1, further comprising:
providing the RF antenna with a first set of contact pads;
providing the RFID module with a second set of contact pads; and
aligning the first and second set of contact pads in a predetermined manner relative to each other when attaching the RFID module to the item whereby the RFID module is non-contact electrically coupled to the RF antenna.

6. The method of claim 1, further comprising providing a dielectric between the RF antenna and the RFID electronic module.

7. A method comprising,
applying an RF antenna directly to an item;
providing an RFID electronics module separate from the item and the RF antenna on the item, the RFID electronics module including electronics that provide an RFID capability when coupled to the RF antenna;
applying the RFID electronics module to the item after applying the RF antenna to the item, whereby the RFID electronics module is electrically coupled to the RF antenna.

8. The method of claim 7, further comprising:
providing alignment features on the item and positioning the RFID electronics module on the item based on a location of the alignment features.

9. The method of claim 7, further comprising providing an adhesive on the RFID electronics module; and applying the RFID electronics module to the item by means of the adhesive.

10. The method of claim 7, further comprising applying the RFID electronics module to the item such that the RFID electronics module is non-contact electrically coupled to the RF antenna.

11. The method of claim 7, further comprising applying the RFID electronics module to the item such that the RFID electronics module is in direct electrical contact with the RF antenna.

12. The method of claim 7, wherein applying the RF antenna to the Item comprises printing the RF antenna on the item.

13. The method of claim 12 wherein the RF antenna is printed on the item using electrically conductive ink.

14. In combination, an item having at least one surface and an RF antenna applied to the surface; and an RFID electronics module separate from the item and from the RF antenna on the item, the RFID electronics module including electronics which provide an RFID capability when coupled to the RF antenna, the RFID electronics module being applied to the item so as to be electrically coupled to the RF antenna and provide an RFID capability for the item.

15. The combination of claim 14, further comprising an adhesive attaching the RFID electronics module to the Item.

16. The combination of claim 14, further comprising a dielectric between the RFID electronics module and the RF antenna.

17. The combination of claim 14, wherein the RFID module is adapted to have its RFID capability modified if the RFID electronics module is tampered or removed from the item.
